(19) United States
(12) Patent Application Publication
(10) Pub. No.: US 2013/0155412 A1
(43) Pub. Date: Jun. 20, 2013

(54) SPECTRUM DETECTING DEVICE AND METHOD FOR OPERATION

(71) Applicant: Industrial Technology Research Institute, HSINCHU (TW)

(72) Inventors: Kuang-Po Chang, Taichung City (TW); Shu-Yi Wang, Tainan City (TW)

(73) Assignee: INDUSTRIAL TECHNOLOGY RESEARCH INSTITUTE, HSINCHU (TW)

(21) Appl. No.: 13/633,569

(22) Filed: Oct. 2, 2012

(30) Foreign Application Priority Data
Dec. 19, 2011 (TW) 100147224

(51) Int. Cl. G01J 3/45; G01J 3/447

(52) U.S. Cl. 356/453; 356/451

(57) ABSTRACT

A spectrum detecting device including a laser apparatus, an optical splitting apparatus, an optical gate, a first polarizer, a second polarizer, and an optical analysis apparatus is provided. The optical splitting apparatus splits the laser beam providing from the laser apparatus into a first and a second light beam, and the second light beam is transmitted to a sample to produce a spectral signal. The optical gate activated by the first light beam is disposed between the optical analysis apparatus and the sample. The first polarizer is disposed between the sample and the optical gate, and the second polarizer is disposed between the optical gate and the optical analysis apparatus. The spectral signal passes through the first polarizer, the optical gate, and the second polarizer to be transmitted and received to the optical analysis apparatus when the optical gate is activated and turned on in a predetermined time period.

This application claims the benefit of Taiwan application Serial No. 100147224, filed Dec. 19, 2011, the disclosure of which is incorporated by reference herein in its entirety.

### BACKGROUND

1. Technical Field

The disclosed embodiments relate in general to a spectrum detecting device and a method for operation, and more particularly to a spectrum detecting device having a time-resolved ability and a method for operation.

2. Description of the Related Art

There are lots of needs for chemical detections in modern daily life, such as detections of residual poisonous metals in 3C products, children toys, and agricultural products, detecting if heavy metal contents in Chinese herbal medicine and soil exceed the legal standards, rapid and accurate classifications of recycling products, rapid ore detections, rapid detections of counter-terrorism related substances in airports, and etc. Therefore, an effective chemical detecting method is required. Among the general methods utilized nowadays, energy dispersive spectrometer (EDS), X-ray photoelectron spectroscopy (XPS), and electron probe micro-analyzer (EPMA) can achieve a ppb level detection, however, vacuum operations and complicated pretreatment of the samples are required. The above-mentioned methods are time-consuming, lack of portability, and are only capable of atomic type detections.

Laser induced breakdown spectrometry (LIBS) is an on-site, rapid, and low-destructive analytic method for chemicals and requiring no pretreatment of samples. When a laser beam is focused on the surface of a sample, a breakdown occurs on the sample, and transient plasma with high energy is produced. The emitted light from the plasma can be transformed into electronic signals with a spectral detector. Since each of elements has its specific spectral fingerprint, such properties can be used to identify a specific chemical by the spectral analysis.

However, the sensitivity limit of LIBS is in general restricted to a 100 ppm level. Among the heavy metals in Chinese medicine, cadmium (Cd), mercury (Hg), arsen (As), and lead (Pb) are the four metals with high toxicity, and the maximum contents of Cd, Hg, As, and Pb are 0.5 ppm, 0.5 ppm, 3 ppm, and 10 ppm, respectively. Therefore, it is required to develop a LIBS method capable of operating heavy metal detections to a sub-ppm level. Further, the emitting spectral signals are usually suffered from the interferences of signals from heat diffusion and background. Therefore, collecting effective emitting spectral signals and increasing sensitivity have always been the objectives in industry.

### SUMMARY

The disclosure is directed to a spectrum detecting device. By using a laser beam to activate an optical gate to make a spectral signal pass through an optical gate in a predetermined time period and be transmitted to an optical analysis apparatus.

According to one embodiment, a spectrum detecting device is provided. The spectrum detecting device comprises a laser apparatus, an optical splitting apparatus, an optical gate, a first polarizer, a second polarizer, and an optical analysis apparatus. The laser apparatus is for providing a laser beam. The optical splitting apparatus is for splitting the laser beam into a first light beam and a second light beam, and the second light beam is transmitted to a sample to produce a spectral signal. The optical gate is disposed between the optical analysis apparatus and the sample, and the first light beam is for activating the optical gate. The first polarizer is disposed between the sample and the optical gate, and the second polarizer is disposed between the optical gate and the optical analysis apparatus. The optical analysis apparatus is for receiving the spectral signal, wherein the spectral signal passes through the first polarizer, the optical gate, and the second polarizer to be transmitted to the optical analysis apparatus when the optical gate is activated and turned on in a predetermined time period.

According to another embodiment, a spectrum detecting method is provided. The method comprises: splitting a laser beam into a first light beam and a second light beam with an optical splitting apparatus; transmitting the second light beam to a sample to produce a spectral signal; activating an optical gate with the first light beam to turn on the optical gate in a predetermined time period; and receiving the spectral signal with an optical analysis apparatus. The optical gate is disposed between the optical analysis apparatus and the sample. The spectral signal passes through a first polarizer, the optical gate, and a second polarizer in regular turn to be transmitted to the optical analysis apparatus when the optical gate is activated and turned on in the predetermined time period.

### BRIEF DESCRIPTION OF THE DRAWINGS

FIG. 1 shows a schematic diagram of the spectrum detecting device according to an embodiment.

FIG. 2A shows a spectrum measured by using the spectrum detecting method according to an embodiment.

FIG. 2B shows a spectrum along the section line 2B-2B′ in the spectrum in FIG. 2A.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

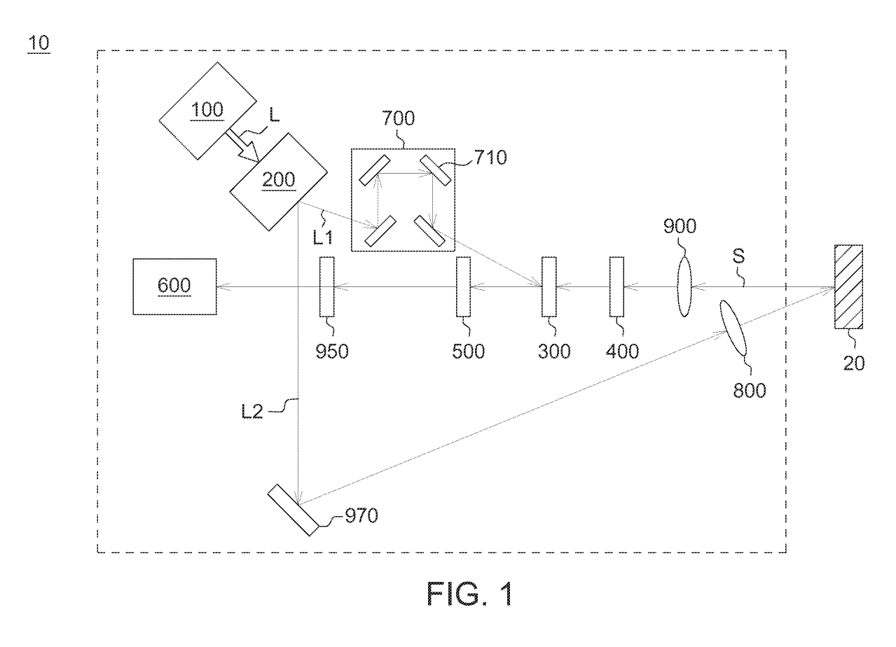

FIG. 1 shows a schematic diagram of the spectrum detecting device according to an embodiment. Spectrum detecting device 10 comprises a laser apparatus 100, an optical splitting apparatus 200, an optical gate 300, a first polarizer 400, a second polarizer 500, and an optical analysis apparatus 600. The laser apparatus 100 is for providing a laser beam L. The optical splitting apparatus 200 is for splitting the laser beam L into a first light beam L1 and a second light beam L2, and the second light beam L2 is transmitted to a sample 20 to produce a spectral signal S. The optical gate 300 is disposed between the optical analysis apparatus 600 and the sample 20, and the first light beam L1 is for activating the optical gate 300. The first polarizer 400 is disposed between the sample 20 and the optical gate 300, and the second polarizer 500 is disposed on the other side of the optical gate 300 opposite to the first polarizer 400, to be clear, the second polarizer 500 is disposed between the optical gate 300 and the optical analysis apparatus 600. The optical analysis apparatus 600 is for receiving the spectral signal S, wherein the spectral signal S passes through the first polarizer 400, the optical gate 300, and the second polarizer 500 to be transmitted to the optical analysis apparatus 600 when the optical gate 300 is activated and turned on in a predetermined time period.

Laser apparatus 100 can be a pulse laser apparatus. In an embodiment, the laser apparatus 100 is, for example, an ultrashort pulse laser apparatus, the laser beam L provided by which is a pulse laser, and the pulse width (the time duration for which the pulse stays) is substantially between 1 femtosecond and 1 nanosecond. The laser beam L can be a single pulse or have a frequency below 1 GHz. The wavelength of the laser beam L is about between 150 and 10600 nanometer (nm). The wavelength of laser beam L is not restricted in the ranges in the disclosure. In an embodiment, the wavelength of the laser beam L is about between 400 and 1000 nm.

The optical splitting apparatus 200 is, for example, a beam splitter, which can effectively divide the laser beam L into the first light beam L1 and the second light beam L2.

As shown in FIG. 1, the spectrum detecting device 10 can further comprise an optical path adjusting apparatus 700. The optical path adjusting apparatus 700 is disposed between the optical splitting apparatus 200 and the optical gate 300 for adjusting a transmitting distance of the first light beam L1 from the optical splitting apparatus 200 to the optical gate 300. The optical path adjusting apparatus 700 can comprises a plurality of reflecting surfaces 710, and the distance between each of the reflecting surfaces 710 is adjustable. By adjusting the distance between each of the reflecting surfaces 710, the transmitting distance of the first light beam L1 from the optical splitting apparatus 200 to the optical gate 300 can be adjusted. By adjusting the transmitting distance of the first light beam L1 from the optical splitting apparatus 200 to the optical gate 300, the time point when the optical gate 300 is turned on can be adjusted, and further, a time difference between the time point when the optical gate 300 is turned on and the time point when the spectral signal S is produced occurs. An appropriate time point when the optical gate 300 is turned on can be obtained with the optical path adjusting apparatus 700, such that a good spectral signal S can be obtained.

The optical gate 300 is, for example, a Kerr gate. The first polarizer 400 and the second polarizer 500 are, for example, linear polarizers, and the difference in polarization angle between the first polarizer 400 and the second polarizer 500 is 90 degrees. In an embodiment, the optical gate 300 is activated by the first light beam L1 and turned on in the predetermined time period, for being capable of changing polarization angles of spectral signal S. After the spectral signal S passes through the first polarizer 400, the turned-on optical gate 300 rotates the polarization angle of the spectral signal S to make it equal to the polarization angle of the second polarizer 500. The term “turn on” here indicates that, for example, a Kerr gate being activated by a laser beam and becoming birefringent, for being capable of changing polarization angles. In an embodiment, the time difference between the time point when the optical gate 300 is turned on and the time point when the spectral signal S is produced is substantially between 0 and 1 microsecond, and the predetermined time period of the optical gate 300 being turned on is substantially between 1 picosecond and 1 nanosecond. As a result, when the optical gate 300 is not activated, the spectral signal S passes through the first polarizer 400 and then is blocked by the optical gate 300, as such the spectral signal S cannot be transmitted to the optical analysis apparatus 600. When the optical gate 300 is activated, after the spectral signal S passes through the first polarizer 400, the spectral signal S is then polarized by 90 degrees after passing through the optical gate 300 and become capable of passing through the second polarizer 500 to be transmitted to the optical analysis apparatus 600. The details of the principles of how the optical gate 300 being activated by the laser beam is not described herein.

Besides, in another embodiment, the optical gate 300, the first polarizer 400, and the second polarizer 500 can be integrated and replaced with an electroptical gate, such as a Pockels cell.

The optical analysis apparatus 600 can comprise a spectrometer, and the optical analysis apparatus 600 can further comprise a detector. The detector converts the received spectral signal S into electronic signal readout. The optical analysis apparatus 600 in the disclosure is not restricted to specific kinds, as long as it can collect spectral signals at different time points at a selected fixing wavelength. In an embodiment, the detector can be a multichannel detector or a single channel detector, such as a photodiode, a streak camera, a charge-coupled device (CCD), or an intensified charge-coupled device (ICCD). In an embodiment, for the signals produced from the laser beam, which detection results can be obtained with a multichannel detector.

As shown in FIG. 1, in an embodiment, the spectrum detecting device 10 can further comprise a first lens 800. The first lens 800 is disposed on a path for the second light beam L2 to travel from the optical splitting apparatus 200 to the sample 20, and the second light beam L2 is focused on the surface of the sample 20 by the first lens 800 to produce the spectral signal S. The spectrum detecting device 10 can further comprise a second lens 900. The second lens 900 is disposed between the sample 20 and the optical analysis apparatus 600 for collecting the spectral signal S to be transmitted to the optical analysis apparatus 600.

As shown in FIG. 1, in an embodiment, the spectrum detecting device 10 can further comprise a filter 950. The filter 950 is disposed between the optical analysis apparatus 600 and the sample 20 for filtering signals except the spectral signal S. The filter 950 can be disposed anywhere between the optical analysis apparatus 600 and the sample 20. For example, the filter 950 can be disposed adjacent to the optical analysis apparatus 600, or the filter 950 can be disposed between the first polarizer 400 and the second polarizer 500. The filter 950 filters out signals except the spectral signal S, such as interferences from the background signals or the reflected laser beam. In another embodiment, by changing the properties of the filter 950, the spectral signal S can be collected by choice. For example, when the filter 950 filters out the signals produced by the second light beam L2 and allows the molecular vibrational energy level signals to pass through, the spectral signal S collected represents a Raman spectral signal. In this case, the spectrum detecting device 10 can be used on collecting a Raman spectrum. Similarly, the spectrum detecting device 10 can also be used on collecting a fluorescence spectrum.

In an embodiment, the laser beam L of the spectrum detecting device 10 can be emitted directed to a sample outside the device to carry out detections. As shown in FIG. 1, the spectrum detecting device 10 can further comprise at least a light beam reflecting surface 970 for reflecting the first light beam L1, the second light beam L2, or both. As such, the whole volume of the spectrum detecting device 10 can be appropriately reduced, and the spectrum detecting device 10 in the embodiment may be a portable spectrum detecting device.

In another embodiment, the spectrum detecting device 10 can be integrated with a laser micro-metal processing equipment, such that detecting and processing can be carried out at the same time.

In the following detailed description, embodiments of a spectrum detecting method are provided with numerous specific details in order to provide a thorough understanding of the disclosure. It will be apparent, however, that one or more embodiments may be practiced without these specific details.

Referring to FIG. 1, a laser beam L is split into a first light beam L1 and a second light beam L2 with an optical splitting apparatus 200. The laser beam L is provided by, such as, a laser apparatus 100. In an embodiment, the laser beam L is a single laser pulse. In another embodiment, the laser beam L comprises a plurality of continuous laser pulses.

The second light beam L2 is transmitted to a sample 20 to produce a spectral signal S, and an optical gate 300 is activated by the first light beam L1 to be turn on in a predetermined time period. In an embodiment, the second light beam L2 is transmitted to the sample 20 to excite plasma to produce the spectral signal S. In another embodiment, the laser beam L comprises a plurality of continuous laser pulses, the first light beam L1 comprises a plurality of continuous first light beam pulses, the second light beam L2 comprises a plurality of continuous second light beam pulses, and the spectral signal S comprises a plurality of continuous spectral signal pulses.

When the optical gate 300 is activated by the first light beam L1, a transmitting distance of the first light beam L1 from the optical splitting apparatus 200 to the optical gate 300 can be optionally adjusted with an optical path adjusting apparatus 700. In an embodiment, the optical path adjusting apparatus 700 comprises a plurality of reflecting surfaces 710. By adjusting the distance between each of the reflecting surfaces 710, the transmitting distance of the first light beam L1 from the optical splitting apparatus 200 to the optical gate 300 can be adjusted, and further, the time point and the predetermined time period when the optical gate 300 is turned on can be adjusted.

The spectral signal S is received by an optical analysis apparatus 600. The optical gate 300 is disposed between the optical analysis apparatus 600 and the sample 20. The spectral signal S passes through a first polarizer 400, the optical gate 300, and a second polarizer 500 in regular turn to be transmitted to the optical analysis apparatus 600 when the optical gate 300 is activated and turned on in a predetermined time period. The first polarizer 400 and the second polarizer 500 are disposed on the two opposite sides of the optical gate 300.

In an embodiment, take laser induced breakdown spectroscopy (LIBS) as an example for illustration. A laser induced breakdown (LIB) spectrum is obtained by collecting spectral signals emitted from plasma produced in the laser ablation process, such that the detection of chemical composition is achieved. In the laser ablation process, typical LIBS signals occur in between about 10 picoseconds and about 10 microseconds, and heat diffusion occurs in about 100 picoseconds, which means that the signals produced from heat diffusion starts occurring in about 100 picoseconds. Therefore, the detection time for LIBS signals is in between about 10 and 100 picoseconds. Activating a Kerr gate by an ultrashort pulse laser (the pulse width of which is at about a femtosecond level) can make the Kerr gate becoming birefringent in a very small time period. The spectral signal S can pass through the Kerr gate in the predetermined time period, and signals cannot pass through the Kerr gate outside the predetermined time period. In an embodiment, the temporal pulse width of the laser pulse is 120 femtoseconds. With the above-mentioned approach, the time resolution of LIB spectrum is increased to about 1 picosecond, and the interferences from noise signals are largely reduced. As such, a high time-resolved ability is achieved, and the detection sensitivity is increased.

The heavier the atoms are, the more quickly the signals are produced. Therefore, the predetermined time period in which the optical gate 300 is turned on can be appropriately chosen according to the atomic mass of the to-be-measured element in the chemical composition of the analyze; as such, an improved signal specificity is obtained. It takes about 1 picosecond for a laser beam to be transmitted a distance of 0.3 millimeters in air. The longer the transmitting distance from the optical splitting apparatus 200 to the optical gate 300 is, the longer the time required for the first light beam L1 to be transmitted to optical gate 300 is, and the later the time point when the optical gate 300 is turned on is. Further, the optical gate 300 can be adjusted to turn on in the predetermined time period with the optical path adjusting apparatus 700, such that the spectral signal S within the predetermined time period can pass through the optical gate 300, and signals outside the predetermined time period cannot pass through the optical gate 300. Conventional spectral detecting methods are not provided with choices of time periods, hence all signals are collected, and the signals within desired time periods are shielded, which leads to the decrease of sensitivity. The time resolution is increased to a picosecond level via the optical gate 300 according to an embodiment of the spectrum detecting method in the disclosure, as such, the intensity of the spectral signal S is increased, interferences from other signals are largely reduced, and the detection sensitivity is increased.

When the spectral signal S is received by the optical analysis apparatus 600, signals except the spectral signal S can be optionally filtered with a filter 950. The filter 950 is disposed between the optical analysis apparatus 600 and the sample 20. The signals filtered with the filter 950 are such as interferences from the background signals or the reflected laser beam.

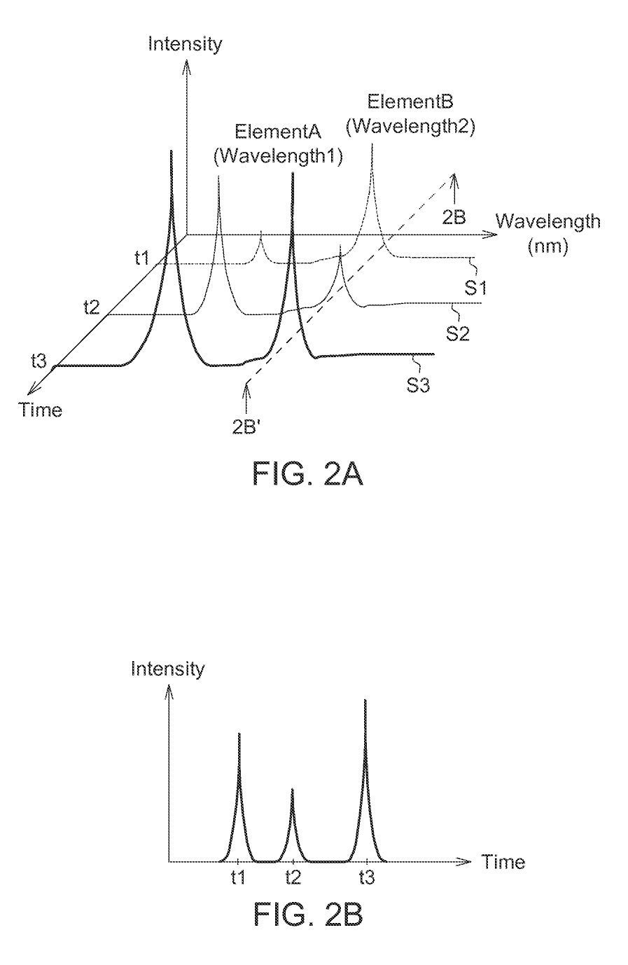

FIG. 2A shows a spectrum measured by using the spectrum detecting method according to an embodiment. In an embodiment, the laser beam L is a single laser pulse, and a spectrum S1 is obtained. The spectral signal S passing through in the predetermined time period t1 is collected by the optical analysis apparatus 600, so the noise signals such as signals from heat diffusion are filtered. Element A and element B are taken as examples, element A has an emission wavelength of wavelength 1, and element B has an emission wavelength of wavelength 2. Although the ranges of wavelength 1 and wavelength 2 are very close, the spectrum S1 with high resolution still can be obtained.

In an another embodiment, the laser beam L comprises a plurality of continuous laser pulses, the first light beam L1 comprises a plurality of continuous first light beam pulses, the second light beam L2 comprises a plurality of continuous second light beam pulses, and the spectral signal S comprises a plurality of continuous spectral signal pulses. When the continuous spectral signal pulses are continuously received by the optical analysis apparatus 600, the transmitting distance of the first light beam L1 from the optical splitting apparatus 200 to the optical gate 300 is continuously adjusted with the optical path adjusting apparatus 700. As such, the transmitting distance of each of the first light beam pulses from the optical splitting apparatus 200 to the optical gate 300 is different from other transmitting distances, and further, each of the predetermined time periods in which the optical gate 300 is activated by each of the first light beam pulses and turned on is different from other predetermined time periods. As shown in FIG. 2A, the laser beam L comprising three continuous laser pulses is taken as an example, the optical gate 300 is activated by the three continuous first light beam pulses, and three time periods t1, t2, and t3 are produced, respectively. Three continuous second light beam pulses are therefore transmitted to the sample, and three continuous spectral signal pulses are produced. The three continuous spectral signal pulses pass through the time periods t1, t2, and t3, respectively, and three spectrums S1, S2, and S3 are collected by the optical analysis apparatus 600. As discussed above, a three-dimensional spectrum, of which the three dimensions are wavelength, intensity, and time, can be collected in one measurement with the spectrum detecting method according to an embodiment in the disclosure. A user can analyze and choose appropriate ranges of the wavelength and time periods, such that accurate detection results can be obtained without multiple trials of detection.

When the wavelength range of an element in an analysis is very close to the wavelength ranges of other elements, by targeting a wavelength at the wavelength of the chosen element in the analysis, which means keeping the wavelength constantly at the wavelength of the chosen element during the whole scanning time, a plurality of spectral signal pulses along a time axis can be collected by scanning spectrum and changing the transmitting distance of the first light beam L1 from the optical splitting apparatus 200 to the optical gate 300 to change the time periods simultaneously. Since the electron transition time for a specific electron of a chosen element is a specific value, a characteristic spectrum of intensity v.s. time can be obtained, which shows the characteristics of the intensity of the energy emitted by the electron transitions of electrons of the chosen element along the detection time axis. Therefore, when an analysis comprises different elements having similar wavelength ranges, the spectrums of wavelength v.s. intensity of which elements may overlap, which makes it difficult to distinguish the different elements. Since the different elements have different characteristic spectrums of intensity v.s. time, a user can still distinguish these elements in the analysis with the method above-mentioned. As such, the detection resolution is increased, and a spectrometer would be not required.

FIG. 2B shows a spectrum along the section line 2B-2B′ in the spectrum in FIG. 2A. In an embodiment, element B is taken as an example, the emission wavelength of element A and the emission wavelength of element B are very close to each other. By fixing the wavelength at wavelength 2 of element B, a characteristic spectrum of intensity v.s. time can be obtained by scanning spectrum and changing the transmitting distance of the first light beam L1 from the optical splitting apparatus 200 to the optical gate 300 simultaneously. The three emission peaks are corresponding to the three time periods t1, t2, and t3, respectively. According to the measured characteristic spectrum of intensity v.s. time, as shown in FIG. 2B, the element in the analysis is determined to be element B.

In an embodiment, the second light beam L2 can be optionally focused on the surface of the sample 20 by a first lens 800. Further, the spectral signal S can be collected with a second lens 900. The first lens 800 and the second lens 900 can be disposed adjacent to the sample 20, and the relative position of the first lens 800 and the second lens 900 is adjustable. The second light beam L2 being focused on the surface of the sample 20 by the first lens 800 refers to the position where the second light beam L2 strikes on the surface of the sample 20, which is the starting point of the production of the spectral signal S of the emitting light from the plasma. The spectral signal S collected with the second lens 900 refers to choosing a position to collect the spectral signal S with the second lens 900, which position refers to a chosen position above the sample 20 where the spectral signal S is collected. The position where the spectral signal S is collected can be different from the position where the second light beam L2 strikes on the surface of the sample 20. For example, the distance between the two positions is 1 mm. The plasma may diffuse in the air, and the emission spectrum may vary when the spatial position where the plasma is taken varies. Therefore, a user may choose an appropriate spatial position to collect the spectral signal S by adjusting the relative position of the first lens 800 and the second lens 900. Further, the characteristics of the emission spectrum may vary when the spatial position where the plasma is taken varies, a user can obtain different characteristic spectrums of intensity v.s. spatial position for different elements.

In an embodiment, the spectral signal S can further comprise a plurality of continuous spectral signal pulses, the predetermined time period can further comprise a plurality of continuous sub-predetermined time periods, the sub-predetermined time periods are different from one another, and each of the spectral signal pulses passes through the optical gate 300 in each of the corresponding sub-predetermined time periods. The spectral signal pulses are continuously received by the optical analysis apparatus 600 in the sub-predetermined time periods, and each of the spectral signal pulses corresponds to one of the time periods. With the spectrum detecting method according to an embodiment in the disclosure, spectral signals at various time points can be collected with the optical analysis apparatus 600 in a single detection. As such, a user can obtain a characteristic spectrum of intensity v.s. time to distinguish elements in the analysis, which elements it has been difficult to distinguish, such that the detection is carried out without a spectrometer required.

In another embodiment, the spectrum detecting method comprises transmitting a laser beam L to a sample 20 to produce a spectral signal S and receiving the spectral signal S with a photoelectric sensing device. The photoelectric sensing device has a time-resolved ability, and the photoelectric sensing device can be, for example, a photodiode or a photomultiplier tube (PMT). Compared to the embodiments described above, the optical gate 300, the first polarizer 400, the second polarizer 500, and the optical path adjusting apparatus 700 can be omitted in this embodiment. Other elements in this embodiment and previous embodiments sharing the same labeling are the same elements, and the description of which are as aforementioned. In an embodiment, the photoelectric sensing device is controlled to be turned on or turned off. The spectral signal S can pass through the photoelectric sensing device when the photoelectric sensing device is turned on in a predetermined time period. The photoelectric sensing device does not require to be activated by a laser beam L or a first light beam L1 to be turned on in the predetermined time period. The spectral signal S passes through the photoelectric sensing device when the photoelectric sensing device is turned on. In applications, the choices of photoelectric sensing device are depending on the conditions applied and are not limited to the photoelectric sensing device aforementioned. Besides, the spectral signal S can comprise a plurality of continuous spectral signal pulses, the predetermined time period comprises a plurality of continuous sub-predetermined time periods, the sub-predetermined time periods are different from one another, and each of the spectral signal pulses passes through the photoelectric sensing device in one of a plurality of continuous sub-predetermined time periods. The spectral signal pulses are received by the photoelectric sensing device in the sub-predetermined time periods, and each of the spectral signal pulses corresponds to one of the time periods. As such, a user can obtain a characteristic spectrum of intensity v.s. time to distinguish elements in an analysis, which elements it has been difficult to distinguish, such that the detection is carried out without a spectrometer required.

According to the aforementioned description, the spectrum detecting device and the spectrum detecting method are exemplified. In the embodiments, via a spectral signal passing through an optical gate which is turned on in a predetermined time period to be transmitted to an optical analysis apparatus or an photoelectric sensing device, a high time-resolved ability is achieved, the intensity of the spectral signal is enhanced, interferences from noise are largely reduced, and the detection sensitivity is increased. Further, the transmitting distance of a first light beam from an optical splitting apparatus to the optical gate is adjusted with an optical path adjusting apparatus to further adjust the predetermined time period when the optical gate or the photoelectric sensing device is turned on, such that a three-dimensional spectrum, of which the three dimensions are wavelength, intensity, and time, can be collected in one measurement, and a user can obtain accurate detection results without multiple trials of detection. Besides, a second light beam can be focused on the surface of the sample by a first lens, and the spectral signal can be collected with a second lens, such that a user may choose an appropriate spatial position to collect the spectral signal by adjusting the relative position of the first lens and the second lens and obtain various characteristic spectrums of intensity v.s. spatial position for different elements.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A spectrum detecting device, comprising:
a laser apparatus for providing a laser beam;
an optical splitting apparatus for splitting the laser beam into a first light beam and a second light beam, wherein the second light beam is transmitted to a sample to produce a spectral signal;
an optical analysis apparatus for receiving the spectral signal;
an optical gate disposed between the optical analysis apparatus and the sample, wherein the first light beam is for activating the optical gate;
a first polarizer disposed between the sample and the optical gate; and
a second polarizer disposed between the optical gate and the optical analysis apparatus,
wherein the spectral signal passes through the first polarizer, the optical gate, and the second polarizer to be transmitted to the optical analysis apparatus when the optical gate is activated and turned on in a predetermined time period.

2. The spectrum detecting device according to claim 1, further comprising:
an optical path adjusting apparatus disposed between the optical splitting apparatus and the optical gate for adjusting a transmitting distance of the first light beam from the optical splitting apparatus to the optical gate.

3. The spectrum detecting device according to claim 2, wherein the optical path adjusting apparatus comprises a plurality of reflecting surfaces, and the distance between each of the reflecting surfaces is adjustable.

4. The spectrum detecting device according to claim 1, wherein the optical gate is a Kerr gate.

5. The spectrum detecting device according to claim 1, wherein the first polarizer and the second polarizer are linear polarizers, and the difference in polarization angles between the first polarizer and the second polarizer is 90 degrees.

6. The spectrum detecting device according to claim 1, further comprising:
a first lens disposed on a path for the second light beam to travel from the optical splitting apparatus to the sample, and the second light beam is focused on the surface of the sample by the first lens.

7. The spectrum detecting device according to claim 1, further comprising:
a second lens disposed between the sample and the optical analysis apparatus for collecting the spectral signal.

8. The spectrum detecting device according to claim 1, further comprising:
a filter disposed between the optical analysis apparatus and the sample for filtering signals except the spectral signal.

9. The spectrum detecting device according to claim 1, wherein the laser beam is a pulse laser, and the pulse laser has a pulse width substantially from 1 femtosecond to 1 nanosecond.

10. The spectrum detecting device according to claim 1, wherein a time difference between the time point when the optical gate is turned on and the time point when the spectral signal is produced is substantially between 0 and 1 microsecond, and the predetermined time period is substantially between 1 picosecond and 1 nanosecond.

11. A spectrum detecting method, comprising:
splitting a laser beam into a first light beam and a second light beam with an optical splitting apparatus;
transmitting the second light beam to a sample to produce a spectral signal;
activating an optical gate by the first light beam to turn on the optical gate in a predetermined time period; and
receiving the spectral signal with an optical analysis apparatus, wherein the optical gate is disposed between the optical analysis apparatus and the sample, and the spectral signal passes through a first polarizer, the optical gate, and a second polarizer in regular turn to be transmitted to the optical analysis apparatus when the optical gate is activated and turned on in the predetermined time period.

12. The spectrum detecting method according to claim 11, further comprising:
adjusting a transmitting distance of the first light beam from the optical splitting apparatus to the optical gate with an optical path adjusting apparatus.

13. The spectrum detecting method according to claim 12, wherein the optical path adjusting apparatus comprises a plurality of reflecting surfaces, and the step of adjusting the transmitting distance of the first light beam from the optical splitting apparatus to the optical gate with the optical path adjusting apparatus comprises:
adjusting the distance between each of the reflecting surfaces.

14. The spectrum detecting method according to claim 12, wherein the laser beam comprises a plurality of continuous laser pulses, the first light beam comprises a plurality of continuous first light beam pulses, and the second light beam comprises a plurality of continuous second light beam pulses.

15. The spectrum detecting method according to claim 14, wherein the step of adjusting the transmitting distance of the first light beam from the optical splitting apparatus to the optical gate with the optical path adjusting apparatus and the step of receiving the spectral signal with the optical analysis apparatus are carried out simultaneously, such that the transmitting distance of each of the first light beam pulses from the optical splitting apparatus to the optical gate is different from other transmitting distances of the first light beam pulses from the optical splitting apparatus to the optical gate.

16. The spectrum detecting method according to claim 14, wherein the spectral signal comprises a plurality of continuous spectral signal pulses, the step of adjusting the transmitting distance of the first light beam from the optical splitting apparatus to the optical gate with the optical path adjusting apparatus and the step of receiving the spectral signal with the optical analysis apparatus are carried out simultaneously, the predetermined time period comprises a plurality of continuous sub-predetermined time periods, the sub-predetermined time periods are different from one another, each of the spectral signal pulses passes through the optical gate in each of the corresponding sub-predetermined time periods, and the spectral signal pulses are received by the optical analysis apparatus in the sub-predetermined time periods.

17. The spectrum detecting method according to claim 11, further comprising:
focusing the second light beam on the surface of the sample by a first lens;
collecting the spectral signal with a second lens; and
adjusting a relative position of the first lens and the second lens.

18. The spectrum detecting method according to claim 11, further comprising:
filtering signals except the spectral signal with a filter, and the filter is disposed between the optical analysis apparatus and the sample.

19. A spectrum detecting method, comprising:
transmitting a laser beam to a sample to produce a spectral signal; and
receiving the spectral signal with a photoelectric sensing device, wherein the photoelectric sensing device has a time-resolved ability, the spectral signal comprises a plurality of continuous spectral signal pulses, each of the spectral signal pulses passes through the photoelectric sensing device in one of a plurality of continuous sub-predetermined time periods, the sub-predetermined time periods are different from one another, and the spectral signal pulses are received by the photoelectric sensing device in the sub-predetermined time periods.
